(19) United States
(12) Patent Application Publication
(10) Pub. No.: US 2026/0131678 A1
(43) Pub. Date: May 14, 2026

(54) CAP MECHANISM AND CHARGING INLET

(71) Applicant: YAZAKI CORPORATION, Tokyo (JP)

(72) Inventors: Hideki Mizuno, Kakegawa-shi (JP); Masanori Nakamura, Kakegawa-shi (JP); Teruhiko Ohike, Kakegawa-shi (JP); Shinichi Kamura, Kakegawa-shi (JP); Takao Murakami, Kakegawa-shi (JP)

(21) Appl. No.: 19/384,644

(22) Filed: Nov. 10, 2025

(30) Foreign Application Priority Data
Nov. 12, 2024 (JP) 2024-197074

(51) Int. Cl. B60L 53/16

(52) U.S. Cl. CPC B60L 53/16

(57) ABSTRACT

According to one embodiment, a cap mechanism is used for a charging inlet that is an in-vehicle component. The charging inlet includes a housing in which an internal space into which a power feeding connector is able to be fitted is formed. The cap mechanism includes a holder attached to the housing, a cap that is rotatably held by the holder and is movable to a closing position at which the cap covers the internal space and an opening position at which the cap opens the internal space, a first biasing member that biases the cap toward the closing position, and a lock mechanism that locks and holds the cap at the opening position in a case where the cap is moved to the opening position, and, in a case where the power feeding connector is inserted into the internal space, releases lock by the power feeding connector abutting, and permits the cap to move toward the closing position.

### BACKGROUND OF THE INVENTION

### Field of the Invention

Embodiments of the present invention relate to a cap mechanism and a charging inlet.

Priority is claimed on Japanese Patent Application No. 2024-197074 filed in Japan on Nov. 12, 2024, the content of which is incorporated herein by reference.

### Description of Related Art

For example, Japanese Unexamined Patent Application, First Publication No. 2012-240645 below discloses a charging inlet of a vehicle including an inlet box attached to an outer panel of the vehicle and a cap joined to the inlet box via a hinge mechanism to open and close an opening of the inlet box.

### PRIOR ART DOCUMENT

### Patent Document

Patent Document 1: Japanese Unexamined Patent Application, First Publication No. 2012-240645

### SUMMARY OF THE INVENTION

However, in the charging inlet of Patent Document 1, it is necessary to manually close the cap after completion of charging, which causes labor on an operator side.

One embodiment is to provide a cap mechanism and a charging inlet capable of reducing labor of an operator at the time of charging.

According to one embodiment, a cap mechanism is used for a charging inlet that is an in-vehicle component, the charging inlet includes a housing in which an internal space into which a power feeding connector is able to be fitted is formed, and the cap mechanism includes a holder attached to the housing, a cap that is rotatably held by the holder and is movable to a closing position at which the cap covers the internal space and an opening position at which the cap opens the internal space, a first biasing member that biases the cap toward the closing position, and a lock mechanism that locks and holds the cap at the opening position in a case where the cap is moved to the opening position, and, in a case where the power feeding connector is inserted into the internal space, releases lock by the power feeding connector abutting, and permits the cap to move toward the closing position.

According to one embodiment, it is possible to reduce labor of an operator at the time of charging.

### BRIEF DESCRIPTION OF THE DRAWINGS

FIG. 1 is a perspective view of a charging inlet in a first embodiment.

FIG. 2 is a schematic cross-sectional view illustrating a structure around a cap mechanism of the charging inlet in the first embodiment.

FIG. 3 is a perspective view of the cap mechanism according to the first embodiment.

FIG. 4 is a plan view illustrating a structure around a holder of the cap mechanism in the first embodiment.

FIG. 5 is a view illustrating a state in which an internal space in the first embodiment is being opened and a power feeding connector is being inserted into the internal space.

FIG. 6 is a view illustrating a state in which the internal space in the first embodiment is opened and the insertion of the power feeding connector has completed.

FIG. 7 is a view illustrating a state immediately after a power feeding connector in the first embodiment is pulled out from the internal space.

FIG. 8 is a schematic cross-sectional view illustrating a structure around a cap mechanism of a charging inlet in a second embodiment.

FIG. 9 is a schematic cross-sectional view illustrating a main part around a cap mechanism in a third embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. The constitution described below does not limit the scope of the embodiments.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only a part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “perpendicular”, or “the same” may include “substantially parallel”, “substantially perpendicular”, or “substantially the same”, respectively.

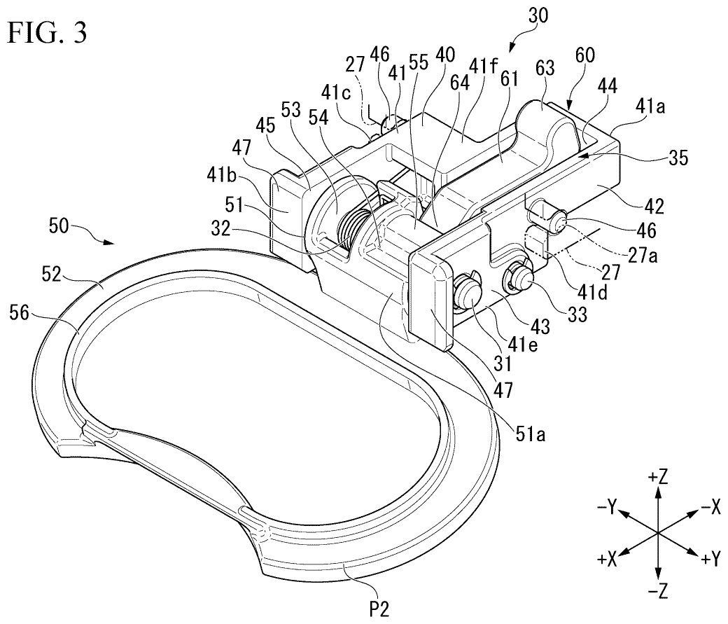

In the present disclosure, a +X direction, a −X direction, a +Y direction, a −Y direction, a +Z direction, and a −Z direction are defined as follows. The +X direction is a direction from a first end surface 41a to a second end surface 41b of a holder body 41 which will be described later (see FIG. 3). The −X direction is a direction opposite to the +X direction. Hereinafter, in a case where the +X direction and the −X direction are not distinguished, the directions will be simply referred to as “X direction”. The +Y direction and the −Y direction are directions intersecting with (for example, perpendicular to) the X direction. The +Y direction is a direction from a third end surface 41c to a fourth end surface 41d of the holder body 41 which will be described later (see FIG. 3). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting with (for example, perpendicular to) the X direction and the Y direction. The +Z direction is a direction from a fifth end surface 41e to a sixth end surface 41f of the holder body 41 which will be described later (see FIG. 3). The −Z direction is a direction opposite to the +Z direction. Hereinafter, in a case where the +Z direction and the −Z direction are not distinguished, the directions will be simply referred to as “Z direction”.

Hereinafter, in a case where the X direction and the Y direction are not distinguished, the directions may be referred to as “horizontal direction”. Hereinafter, the present embodiment will be described with an example in which the X direction is the “front-rear direction”, the Y direction is the “right-left direction”, and the Z direction is the “up-down direction”. Hereinafter, the +Z direction side is referred to as “upper”, and the −Z direction side is referred to as “lower”. However, these expressions do not limit the gravity direction of a charging inlet 1 (installation posture of the charging inlet 1).

### First Embodiment

### 1. Constitution of Charging Inlet

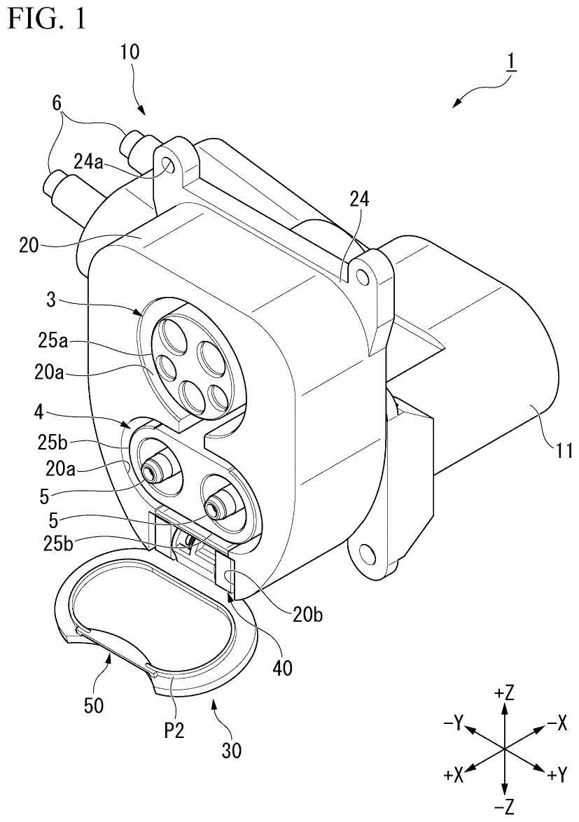

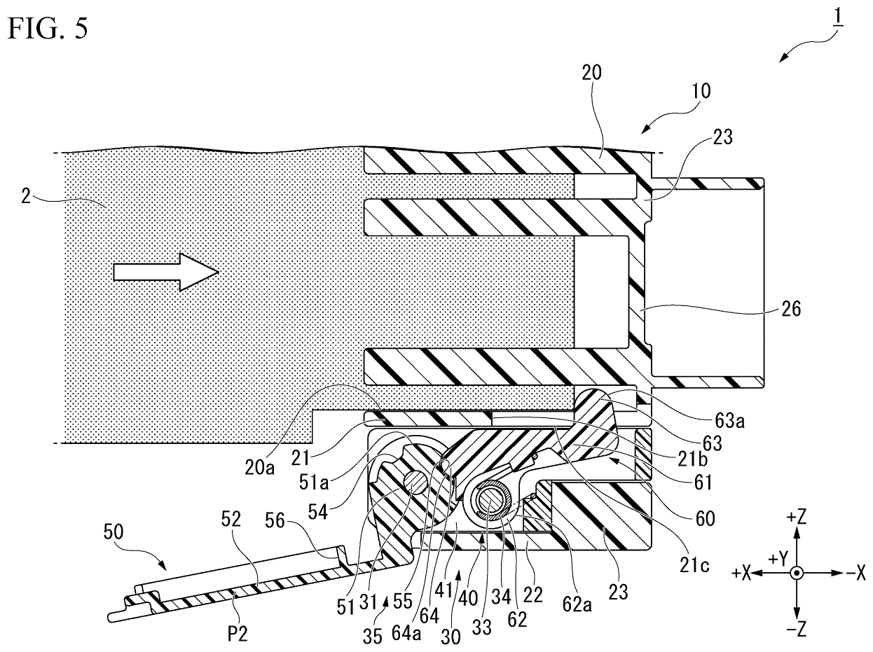

FIG. 1 is a perspective view of a charging inlet 1 in the first embodiment. The charging inlet 1 is an in-vehicle component. The charging inlet 1 is a connector to be assembled to a vehicle body of a vehicle equipped with a battery, such as an electric vehicle (EV) or a plug-in hybrid electric vehicle (PHEV). A power feeding connector 2 (see FIG. 5) on a power feeding device (not illustrated) side is fitted to the charging inlet 1 when the battery of the vehicle is charged. In a state where the power feeding connector 2 is fitted to the charging inlet 1, power is fed from the power feeding device to the vehicle side to charge the battery.

The charging inlet 1 according to the present embodiment includes a first connector portion 3 and a second connector portion 4, and a plurality of signal terminals and power terminals are mounted from the −X direction side of the first connector portion 3 and the second connector portion 4. For example, a plurality of signal terminals connected to a signal line and a pair of power terminals connected to a power line are inserted into and mounted on the first connector portion 3. For example, a pair of power terminals 5 connected to the power line is inserted and mounted on the second connector portion 4. The charging inlet 1 includes a housing 10 and a cap mechanism 30.

### 2. Constitution of Housing

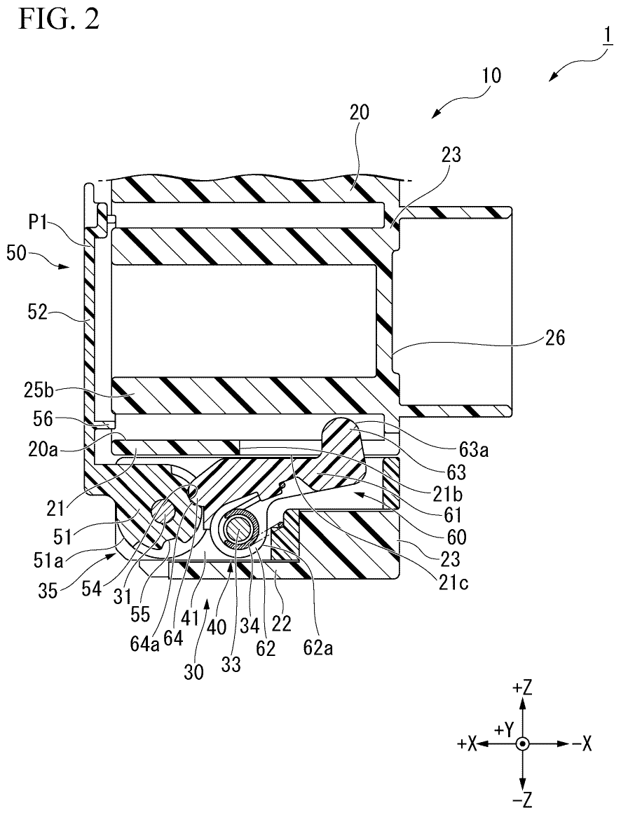

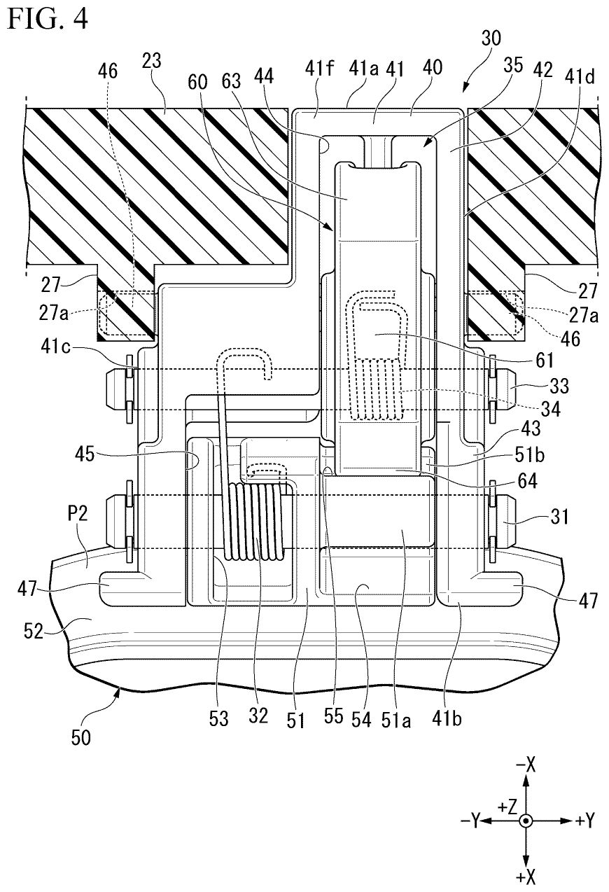

The housing 10 includes a front housing 20 and a rear housing 11. The front housing 20 is molded from synthetic resin. The front housing 20 includes an internal space 20a, an accommodation chamber 20b, a partition wall 21, an AC socket 25a, a DC socket 25b, a barrier wall 23 (see FIG. 2), an attachment flange 24, and a holding portion 27 (see FIGS. 3 and 4).

The internal space 20a is formed in the front housing 20. The internal space 20a is open to the +X direction side. The internal space 20a is fitted to the power feeding connector 2 (see FIG. 5) inserted from the +X direction side. In the present embodiment, two internal spaces 20a are provided side by side in the up-down direction (Z direction). The cylindrical AC socket 25a is disposed in the internal space 20a on the upper side (+Z direction side), and the signal terminal and the power terminal (not illustrated) are inserted into the AC socket 25a from the −X direction side. Only one AC socket 25a is disposed in the upper internal space 20a, and the internal space 20a is formed in a cylindrical shape to follow the outer shape of the AC socket 25a. The upper internal space 20a, the AC socket 25a, the signal terminal, and the power terminal constitute the first connector portion 3.

On the other hand, the cylindrical DC socket 25b extending in the X direction is disposed in the internal space 20a on the lower side (−Z direction side), and the power terminal 5 is inserted into the DC socket 25b from the −X direction side. The power terminal 5 is a charging terminal through which a charging current flows, and is an example of a “terminal”. In the lower internal space 20a, two DC sockets 25b adjacent in the Y direction are arranged, and formed in an elliptical shape elongated in the Y direction as viewed from the X direction to cover the two DC sockets 25b from the outer peripheral side. By inserting the power feeding connector 2 into the lower internal space 20a, the power feeding connector 2 is connected to the power terminal 5. The lower internal space 20a, the DC socket 25b, and the power terminal 5 constitute the second connector portion 4.

The upper internal space 20a and the lower internal space 20a communicate with each other in the X direction. Hereinafter, the upper internal space 20a in which the AC socket 25 a is disposed may be referred to as an “AC-side internal space 20a”, and the lower internal space 20a in which the DC socket 25b is disposed may be referred to as a “DC-side internal space 20a”. In the following description, the lower (DC-side) internal space 20a will be described, and it is assumed that unless otherwise specified, the internal space 20a means the lower (DC-side) internal space 20a.

The accommodation chamber 20b in which the cap mechanism 30 to be described later is accommodated is formed below the internal space 20a. The partition wall 21 extending in the X direction and the Y direction is formed between the internal space 20a and the accommodation chamber 20b. The partition wall 21 partitions the internal space 20a and the accommodation chamber 20b. An insertion hole 21b that penetrates the partition wall 21 in the Z direction is formed in the partition wall 21. A protrusion 63 of a lever 60 which will be described later is inserted into the insertion hole 21b. The barrier wall 23 (see FIG. 2) is provided in a portion of the front housing 20 on the −X direction side. The barrier wall 23 extends in the Y direction and the Z direction and is located at the rear ends of the internal space 20a and the accommodation chamber 20b. In the barrier wall 23, a terminal accommodation chamber 26 (see FIG. 2) is formed at a position facing the AC socket 25a and the DC socket 25b in the X direction. When a terminal such as the power terminal 5 is inserted into the terminal accommodation chamber 26 from the −X direction side, the terminal is inserted into each of the sockets 25a and 25b. The attachment flange 24 projects from the outer peripheral surface of the front housing 20 to the outer peripheral side. The attachment flange 24 has a bolt hole 24a, and an attachment bolt (not illustrated) inserted into the bolt hole 24a is screwed into a screw hole (not illustrated) of the vehicle, whereby the charging inlet 1 is attached to the vehicle.

The holding portion 27 (see FIGS. 3 and 4) is provided on a surface directed to the +X direction side of the barrier wall 23. A pair of holding portions 27 protrudes in the +X direction from the barrier wall 23 and is provided to be spaced apart from each other in the Y direction. The holding portion 27 has a holding groove 27a. The holding groove 27a is open in the +X direction. The holding groove 27a is formed in a C shape as viewed in the Y direction. The holding groove 27a holds a holding target shaft 46 of a holder 40 which will be described later.

The rear housing 11 is attached to a portion (portion constituting the second connector portion 4) constituting the lower (DC-side) internal space 20a of the front housing 20 from the −X direction side. The rear housing 11 is molded from synthetic resin. An electric wire 6 connected to the power terminal 5 is drawn out from the rear housing 11.

### 3. Cap Mechanism

FIG. 2 is a schematic cross-sectional view illustrating a structure around the cap mechanism 30 of the charging inlet 1 in the first embodiment. FIG. 3 is a perspective view of the cap mechanism 30 according to the first embodiment. FIG. 4 is a plan view illustrating a structure around the holder 40 of the cap mechanism 30 in the first embodiment. The cap mechanism 30 is used for the charging inlet 1. The cap mechanism 30 is attached to a portion of the housing 10 on the −Z direction side. The cap mechanism 30 is a member having a structure different from that of the housing 10. The cap mechanism 30 includes a holder 40, a cap 50, a first biasing member 32, and a lock mechanism 35.

### Holder

The holder 40 is accommodated in the accommodation chamber 20b. The holder 40 is attached to the housing 10 to face an attachment surface 21c of the partition wall 21 directed to the −Z direction side from the-Z direction side. The holder 40 is provided separately from the housing 10, and is detachably attached to the housing 10. The holder 40 is supported from the −Z direction side by the lower surface of the accommodation chamber 20b. The holder 40 includes a holder body 41, a holding target shaft 46, and a projection portion 47.

The holder body 41 includes a first body portion 42 and a second body portion 43 arranged in the X direction. The first body portion 42 and the second body portion 43 are both formed in a rectangular parallelepiped shape having sides in the X direction, the Y direction, and the Z direction. The dimensions of the first body portion 42 in the X direction, the Y direction, and the Z direction are designed to be smaller than the dimensions of the second body portion 43 in the X direction, the Y direction, and the Z direction, respectively. The upper surface (the surface directed to the +Z direction) of the first body portion 42 and the upper surface of the second body portion 43 are continuously located in the same plane shape. In addition, a surface of the first body portion 42 directed to the +Y direction and a surface of the second body portion 43 directed to the +Y direction are continuous. From another viewpoint, the holder body 41 includes a first end surface 41a, a second end surface 41b, a third end surface 41c, a fourth end surface 41d, a fifth end surface 41e, and a sixth end surface 41f. The first end surface 41a is a surface of the holder body 41 directed to the −X direction, and the second end surface 41b is a surface of the holder body 41 directed to the +X direction. The first end surface 41a and the second end surface 41b are a pair of end surfaces in the front-rear direction, and are spaced apart in the X direction. The third end surface 41c and the fourth end surface 41d are a pair of end surfaces in the right-left direction, and are spaced apart in the Y direction. The third end surface 41c is a surface of the holder body 41 directed to the −Y direction, and the fourth end surface 41d is a surface of the holder body 41 directed to the +Y direction. The fifth end surface 41e and the sixth end surface 41f are a pair of end surfaces in the up-down direction, and are spaced apart in the Z direction. The fifth end surface 41e is a surface of the holder body 41 directed to the −Z direction, and the sixth end surface 41f is a surface of the holder body 41 directed to the +Z direction. The sixth end surface 41f of the holder body 41 faces the attachment surface 21c of the partition wall 21, and the fifth end surface 41e of the holder body 41 abuts on the lower surface of the accommodation chamber 20b.

In the holder body 41, a first accommodation chamber 44 and a second accommodation chamber 45 are formed. The first accommodation chamber 44 is provided in a portion of the holder body 41 on the −X direction side. The second accommodation chamber 45 is provided in a portion of the holder body 41 on the +X direction side. The first accommodation chamber 44 is provided from the first body portion 42 to the second body portion 43. The first accommodation chamber 44 penetrates the holder body 41 in the up-down direction. The second accommodation chamber 45 communicates with the first accommodation chamber 44 and extends from the first accommodation chamber 44 in the +Z direction. The second accommodation chamber 45 penetrates the holder body 41 in the up-down direction and is open to the +X direction side. The dimension of the second accommodation chamber 45 in the Y direction is larger than the dimension of the first accommodation chamber 44 in the Y direction. A portion of the lever 60, which will be described later, on the −X direction side is accommodated in the first accommodation chamber 44, and a portion of the lever 60 on the +X direction side and a rotating portion 51 which will be described later are accommodated in the second accommodation chamber 45.

The holding target shaft 46 is provided at an end portion of the second body portion 43 on the −X direction side. The holding target shaft 46 is provided on each of the third end surface 41c and the fourth end surface 41d and protrudes in the Y direction. The holding target shaft 46 is disposed on the same axis. The holding target shaft 46 is engaged with the holding groove 27a of the holding portion 27 formed in the housing 10. The holder 40 is held at a predetermined position in the housing 10 by engagement between the holding target shaft 46 and the holding portion 27. For example, the holder 40 is fixed to the housing 10 by snap-fitting the holding target shaft 46 to the holding groove 27a. Therefore, an operator can easily pull out the holding target shaft 46 from the holding groove 27a and release the engagement between the holding target shaft 46 and the holding portion 27, only by pulling out the holder 40 in the +X direction. By releasing the engagement between the holding target shaft 46 and the holding portion 27, the holder 40 can be detached from the housing 10. Due to such engagement between the holding target shaft 46 and the holding portion 27, the holder 40 is detachably attached to the housing 10.

The projection portion 47 is provided at an end portion of the holder body 41 on the +X direction side. The projection portion 47 projects in the Y direction from the third end surface 41c and the fourth end surface 41d of the holder body 41. An end surface of the projection portion 47 on the +X direction side is continuous with the second end surface 41b of the holder body 41 and is located flush with the second end surface 41b.

### First Shaft

A first shaft 31 is attached to the holder body 41. The first shaft 31 is accommodated in a region of the second accommodation chamber 45 on the +X direction side. The first shaft 31 extends in the Y direction and penetrates the holder body 41. Both end portions of the first shaft 31 are supported by the third end surface 41c and the fourth end surface 41d of the holder body 41.

### Cap

The cap 50 is held by the holder 40 to be rotatable about the first shaft 31. The cap 50 is provided movably between a closing position P1 at which the cap covers the internal space 20a by rotating about the first shaft 31 and an opening position P2 at which the cap opens the internal space 20a. The cap 50 is molded from synthetic resin. The cap 50 includes a cap body 52 and an upright portion 56.

The cap body 52 is formed in an elliptical shape that is elongated in the Y direction and has the same shape as the shape of the DC-side internal space 20a. The cap body 52 is a member that opens and closes the internal space 20a. At the closing position P1, the cap body 52 is disposed to extend in the up-down direction (Z direction) and covers the internal space 20a. At the opening position P2, the cap body 52 is disposed to extend in the horizontal direction, and opens the internal space 20a. At the opening position P2, the cap body 52 is located on the −Z direction side with respect to the internal space 20a, and is slightly inclined with respect to the horizontal plane to be gradually located on the −Z direction side as it goes toward the +X direction from the first shaft 31 (see FIG. 5).

The upright portion 56 is formed to rise perpendicularly to the cap body 52. The upright portion 56 is formed in an elliptical shape along the outer peripheral edge of the cap body 52. At the closing position P1, the upright portion 56 is disposed at a position along the internal space 20a.

### First Biasing Member

The first biasing member 32 biases the cap 50 toward the closing position P1. The first biasing member 32 in the present embodiment is a torsion spring wound around the first shaft 31. The first biasing member 32 is held by the holder 40 and is accommodated in a root accommodation chamber 53 of the rotating portion 51 which will be described later. One end of the first biasing member 32 is fixed to the holder 40, and the other end of the first biasing member 32 is fixed to the rotating portion 51.

### Lock Mechanism

In a case where the cap 50 is moved to the opening position P2, the lock mechanism 35 locks and holds the cap 50 at the opening position. Further, in a case where the power feeding connector 2 is inserted into the internal space 20a, the lock mechanism 35 releases the lock by the power feeding connector 2 abutting, and permits the cap 50 to move toward the closing position P1. Hereinafter, the structure of the lock mechanism 35 will be described in detail. The lock mechanism 35 includes the rotating portion 51, a second shaft 33, the lever 60, and a second biasing member 34.

### Rotating Portion

The rotating portion 51 is provided integrally with the cap 50. The rotating portion 51 is provided at an end portion of the cap body 52 on the −X direction-side. The rotating portion 51 is attached to the first shaft 31 and is formed in a cylindrical shape extending in the Y direction around the first shaft 31. The first shaft 31 is inserted through the rotating portion 51. The rotating portion 51 is a member that is integrated with the first shaft 31 and is rotatable about the first shaft 31. The rotating portion 51 includes the root accommodation chamber 53, a closing engagement groove 54, and an opening engagement groove 55. The root accommodation chamber 53 is formed on the −Y direction side of the rotating portion 51. The root accommodation chamber 53 accommodates a portion of the first shaft 31 on the −Y direction side and the first biasing member 32. The closing engagement groove 54 and the opening engagement groove 55 are formed on the +Y direction side of the rotating portion 51. The closing engagement groove 54 and the opening engagement groove 55 are formed on an outer peripheral surface 51a of the rotating portion 51. The closing engagement groove 54 and the opening engagement groove 55 are provided side by side in the circumferential direction. The closing engagement groove 54 is located on the +Z direction side with respect to the opening engagement groove 55 at the closing position P1 (see FIG. 2), and the closing engagement groove 54 is located on the +X direction side with respect to the opening engagement groove 55 at the opening position P2. The closing engagement groove 54 extends in an extending direction (Y direction) of the first shaft 31. At the closing position P1, the closing engagement groove 54 is engaged with an engagement claw 64 of the lever 60 which will be described later. The opening engagement groove 55 extends in an extending direction (Y direction) of the first shaft 31. At the opening position P2, the opening engagement groove 55 is engaged with an engagement claw 64 of the lever 60 which will be described later. The opening engagement groove 55 is an example of an engagement groove.

### Second Shaft

The second shaft 33 is attached to the holder body 41. The second shaft 33 is accommodated in a region of the second accommodation chamber 45 on the −X direction side. The second shaft 33 is disposed on the −X direction side and the −Z direction side with respect to the first shaft 31. The second shaft 33 extends in the Y direction and penetrates the holder body 41. Both end portions of the second shaft 33 are supported by the third end surface 41c and the fourth end surface 41d of the holder body 41.

### Lever

The lever 60 is provided to be engageable with the opening engagement groove 55 and the closing engagement groove 54. In a case where the cap 50 is opened to the opening position P2, the cap 50 is locked and held at the opening position P2 by engaging the lever 60 with the opening engagement groove 55. In a case where the power feeding connector 2 is inserted into the internal space, the power feeding connector 2 abuts on the lever 60, and the lever 60 is removed from the opening engagement groove 55, whereby the lock is released at the opening position P2. Hereinafter, a detailed structure of the lever 60 will be described. The lever 60 is held by the holder 40. The lever 60 is disposed on the −X direction side with respect to the rotating portion 51. The lever 60 is provided to be rotatable about the second shaft 33. The lever 60 is molded from synthetic resin. The lever 60 includes a lever body 61, a lever attachment portion 62, the protrusion 63, and an engagement claw 64. The lever body 61 extends to the back side (−X direction side) in the insertion direction of the power feeding connector 2 to connect the protrusion 63 and the engagement claw 64. The lever body 61 is an example of a first portion of the lever 60. The lever attachment portion 62 is provided at an end portion of the lever body 61 on the +X direction side and protrudes in the −Z direction from the lever body 61 portion. The lever attachment portion 62 is formed in a tubular shape extending in the Y direction around the second shaft 33. The second shaft 33 is inserted into the lever attachment portion 62. The lever attachment portion 62 is a member that is integrated with the second shaft 33 and is rotatable about the second shaft 33. An outer peripheral surface 62a of the lever attachment portion 62 directed to the −Z direction is formed to be curved in an arc shape projecting outward as viewed in the Y direction.

The protrusion 63 is provided at an end portion of the lever body 61 on the −X direction-side. The protrusion 63 is formed to be bent from the lever body 61 to the inner side of the internal space 20a. The protrusion 63 is an example of a second portion of the lever 60. When the lever 60 is biased by the second biasing member 34 which will be described later, the protrusion 63 is inserted into the insertion hole 21b penetrating the partition wall 21 in the Z direction and protrudes into the internal space 20a. An outer peripheral surface 63a of the protrusion 63 directed to the +Z direction is formed to be curved in an arc shape projecting outward as viewed in the Y direction. In a case where the power feeding connector 2 (see FIG. 5) is inserted into the internal space 20a, the power feeding connector 2 abuts on the protrusion 63.

The engagement claw 64 is provided at an end portion of the lever body 61 on the +X direction side. In a case where the cap 50 is moved from the closing position P1 to the opening position P2, the engagement claw 64 is engaged with the opening engagement groove 55, whereby the cap 50 is locked at the opening position P2. In a case where the cap 50 is moved from the opening position P2 to the closing position P1, the engagement claw 64 engages with the closing engagement groove 54, whereby the cap 50 is locked at the closing position P1. As described above, the cap mechanism 30 in the present embodiment includes a cam structure in which the engagement claw 64 and the opening engagement groove 55 (or the closing engagement groove 54) are engaged and disengaged by the movement of the cap 50. An outer peripheral surface 64a of the engagement claw 64 directed to the +X direction is formed to be curved in an arc shape projecting outward as viewed in the Y direction.

### Second Biasing Member

In a case where the lever 60 is engaged with the opening engagement groove 55, the second biasing member 34 performs biasing to hold the position of the lever 60. Specifically, the second biasing member 34 biases the lever 60 in a rotation direction toward the internal space 20a. The second biasing member 34 in the present embodiment is a torsion spring wound around the second shaft 33. The second biasing member 34 is held by the holder 40 and accommodated in the lever 60. One end of the second biasing member 34 is fixed to the holder 40, and the other end of the second biasing member 34 is fixed to the lever 60.

### 4. Operation of Cap Mechanism at Time of Charging Operation

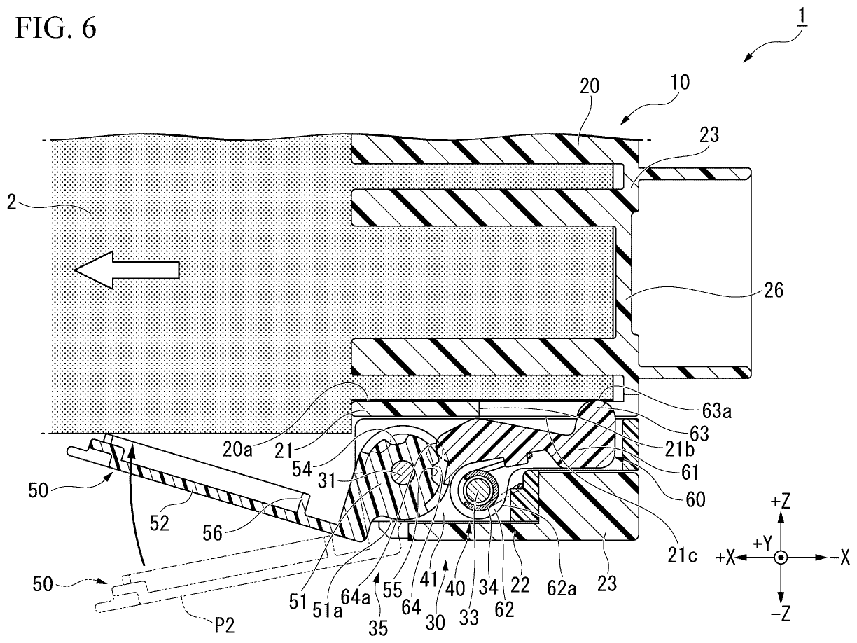

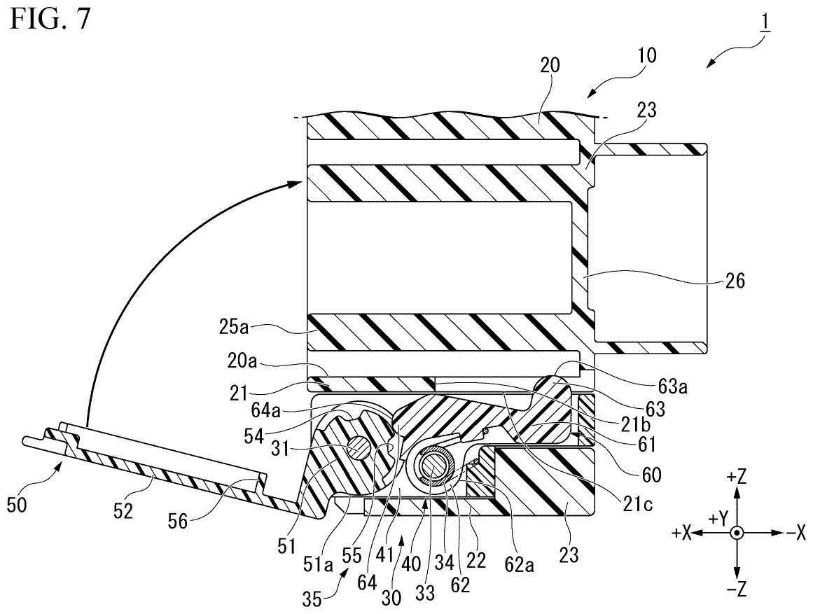

Next, an operation of the cap mechanism 30 at the time of a charging operation will be described with reference to FIGS. 2 and 5 to 7. FIG. 5 is a view illustrating a state in which the internal space 20a in the first embodiment is being opened and the power feeding connector 2 is being inserted into the internal space 20a. FIG. 6 is a view illustrating a state in which the internal space 20a in the first embodiment is opened and the insertion of the power feeding connector 2 has completed. FIG. 7 is a view illustrating a state immediately after the power feeding connector 2 in the first embodiment is pulled out from the internal space 20a. In each drawing, an insertion position of the power feeding connector 2 is schematically illustrated. The operator grips the cap body 52 at the closing position P1 illustrated in FIG. 2 and moves the cap body in the −Z direction. As a result, as illustrated in FIG. 5, the cap 50 rotates counterclockwise about the first shaft 31 as viewed from the +Y direction, and moves from the closing position P1 to the opening position P2. With this movement, the rotating portion 51 rotates counterclockwise about the first shaft 31, and the opening engagement groove 55 moves in the +Z direction. With such movement, at the opening position P2, the engagement claw 64 of the lever 60 enters into the opening engagement groove 55, and the engagement claw 64 and the opening engagement groove 55 are engaged with each other. When the engagement claw 64 and the opening engagement groove 55 are engaged with each other, the cap 50 is locked at the opening position P2.

Thereafter, if the operator inserts the power feeding connector 2 into the internal space 20a in the −X direction, when the power feeding connector 2 reaches the end portion of the internal space 20a in the −X direction, as illustrated in FIG. 6, the protrusion 63 of the lever 60 moves in a direction pushed out from the insertion hole 21b by the power feeding connector 2 (−Z direction). With the movement of the protrusion 63 in the −Z direction, the lever 60 rotates clockwise about the second shaft 33 as viewed from the +Y direction. That is, the lever 60 rotates about the second shaft 33 in a direction in which the protrusion 63 moves away from the internal space 20a in the −Z direction. With such rotation of the lever 60, the engagement claw 64 moves in the +Z direction to the internal space 20a, opposite to the protrusion 63. With such movement of the engagement claw 64, the engagement claw 64 is detached from the opening engagement groove 55, and the engagement between the engagement claw 64 and the opening engagement groove 55 is released. When the engagement between the engagement claw 64 and the opening engagement groove 55 is released, the lock of the cap 50 is released. Then, the cap 50 starts to rotate about the first shaft 31 from the opening position P2 toward the closing position P1 by a biasing force of the first biasing member 32. Thereafter, the end portion of the cap 50 on the +X direction side abuts on the power feeding connector 2 from the −Z direction, and the rotation of the cap 50 is temporarily stopped.

When the charging is completed and the power feeding connector 2 is completely pulled out from the internal space 20a as illustrated in FIG. 7, the cap 50 is again rotated by the first biasing member 32 about the first shaft 31 in the direction from the opening position P2 toward the closing position P1. As illustrated in FIG. 2, when the cap 50 moves to the closing position P1, the internal space 20a is covered with the cap 50. At this time, the engagement claw 64 of the lever 60 enters into the closing engagement groove 54, and the engagement claw 64 and the closing engagement groove 54 are engaged. When the engagement claw 64 and the closing engagement groove 54 are engaged with each other, the cap 50 is locked at the closing position P1. At the closing position P1, the cap body 52 and the projection portion 47 of the holder 40 abut on each other. When the cap 50 returns to the closing position P1, the protrusion 63 of the lever 60 is inserted into the insertion hole 21b of the partition wall 21 and returned to a position protruding into the internal space 20a by the biasing force of the second biasing member 34. As described above, after completion of charging, the power feeding connector 2 is pulled out from the internal space 20a of the charging inlet 1, whereby the charging inlet 1 is automatically returned to the state before the start of the charging operation. Through the above procedure, the operation of the cap mechanism 30 at the time of the charging operation is completed.

### 5. Advantages

In the present embodiment, the cap mechanism 30 includes the holder 40, the cap 50, the first biasing member 32, and the lock mechanism 35. The holder 40 is attached to the housing 10. The cap 50 is rotatably held by the holder 40. The cap 50 is provided movably between the closing position P1 at which the cap covers the internal space 20a of the front housing 20 and the opening position P2 at which the cap opens the internal space 20a. The first biasing member 32 biases the cap 50 toward the closing position P1. In a case where the cap 50 is moved to the opening position P2, the lock mechanism 35 locks and holds the cap 50 at the opening position P2. Further, in a case where the power feeding connector 2 is inserted into the internal space 20a, the lock mechanism 35 releases the lock by the power feeding connector 2 abutting, and permits the cap 50 to move toward the closing position P1.

According to such a constitution, when the cap 50 is moved to the opening position P2, the cap 50 is locked at the opening position P2 by the lock mechanism 35. Therefore, the operator can insert the power feeding connector 2 into the internal space 20a without supporting the cap 50 at the opening position P2 with his/her hand. Further, when the power feeding connector 2 is inserted into the internal space 20a, the power feeding connector 2 abuts on the lock mechanism 35, and thus the lock is released. After the completion of charging, when the power feeding connector 2 is completely pulled out from the internal space 20a, the cap 50 is returned to the closing position P1 by the biasing force of the first biasing member 32. Therefore, it is not necessary for the operator to manually close the cap 50 after completion of charging, and labor on the operator side is reduced.

In the present embodiment, the lock mechanism 35 includes the rotating portion 51 and the lever 60. The rotating portion 51 is provided integrally with the cap 50. The rotating portion 51 has the opening engagement groove 55 on the outer peripheral surface 51a. The lever 60 is engageable with the opening engagement groove 55. In a case where the cap 50 is opened to the opening position P2, the cap 50 is held in a state where the cap 50 is locked at the opening position P2 by engaging the lever 60 with the opening engagement groove 55. In a case where the power feeding connector 2 is inserted into the internal space 20a, the power feeding connector 2 abuts on the lever 60, and the lever 60 is removed from the opening engagement groove 55, and thus the lock is released at the opening position P2 of the cap 50.

According to such a constitution, when the cap 50 is moved to the opening position P2, the opening engagement groove 55 of the cap 50 and the lever 60 are engaged, and the cap 50 is locked at the opening position P2. Further, when the power feeding connector 2 is inserted into the internal space 20a, the power feeding connector 2 causes the lever 60 to be removed from the opening engagement groove 55, and the lock is released at the opening position P2 of the cap 50.

In the present embodiment, the lock mechanism 35 includes the second biasing member 34. In a case where the lever 60 is engaged with the opening engagement groove 55, the second biasing member 34 performs biasing to hold the position of the lever 60.

According to such a constitution, the engagement between the lever 60 and the opening engagement groove 55 is strongly held by the biasing force of the second biasing member 34. Further, when the power feeding connector 2 is completely pulled out from the internal space 20a after the completion of charging, the lever 60 is returned to a state where the protrusion 63 protrudes into the internal space 20a by the biasing force of the second biasing member 34. As described above, only by pulling out the power feeding connector 2 after completion of charging, the lever 60 is automatically returned to the arrangement before charging.

In the present embodiment, the lever 60 includes the lever body 61 and the protrusion 63. The lever body 61 extends toward the back side in the insertion direction of the power feeding connector 2. The protrusion 63 is bent from the lever body 61 to the inside of the internal space 20a. In a case where the power feeding connector 2 is inserted into the internal space 20a, the power feeding connector 2 abuts on the protrusion 63.

According to such a constitution, a contact point 65 between the power feeding connector 2 and the protrusion 63 can be disposed on the −Z direction side (rear side). Thus, it is possible to delay a timing at which the power feeding connector 2 and the protrusion 63 come into contact with each other. Therefore, a timing of releasing the engagement between the engagement claw 64 and the opening engagement groove 55 is delayed, and it is possible to suppress the cap 50 and the power feeding connector 2 from coming into contact with each other and rubbing between the cap 50 and the power feeding connector 2.

In the present embodiment, the closing engagement groove 54 is formed on the outer peripheral surface 51a of the rotating portion 51. In a case where the cap 50 is moved from the opening position P2 to the closing position P1, the engagement claw 64 is engaged with the closing engagement groove 54.

According to such a constitution, when the cap 50 is returned from the opening position P2 to the closing position P1, the engagement claw 64 is less likely to be caught by the rotating portion 51 of the cap 50, and the lever 60 easily returns to the state before the start of charging. Further, the engagement claw 64 is engaged with the closing engagement groove 54, whereby the cap 50 is locked at the closing position P1. Therefore, unless the operator performs an operation of opening the cap 50, an occurrence of a situation in which the internal space 20a is opened at a timing not intended by the operator is suppressed.

In the present embodiment, the holder 40 that holds a constitution other than the holder 40 constituting the cap mechanism 30 is provided separately from the housing 10 and is detachably attached to the housing 10. According to such a constitution, the cap mechanism 30 is separated from the housing 10 and is easily attached to and detached from the housing 10, and for example, when the cap 50 needs to be replaced, the cap 50 can be removed from the housing 10 without using a special tool. For example, in the present embodiment, the housing 10 has the holding portion 27 in which the holding groove 27a is formed, and the holder 40 has the holding target shaft 46 that is snap-fitted to the holding groove 27a. As a result, fixing of the holder 40 can be released and the cap mechanism 30 can be removed from the housing 10 only by the operator pulling out the holder 40 in the +X direction. In the present embodiment, as a mechanism that allows the cap mechanism 30 and the housing 10 to be attached to and detached from each other, the holding target shaft 46 and the holding groove 27a that snap fit are exemplary examples, but the present embodiment is not limited thereto. As the mechanism that allows the cap mechanism 30 and the housing 10 to be attached to and detached from each other, a mechanism other than snap-fit may be adopted.

### Second Embodiment

Next, a second embodiment will be described. The second embodiment is different from the first embodiment in that a damper portion 70 is provided on the first shaft 31. The constitution other than that described below is the same as that of the first embodiment.

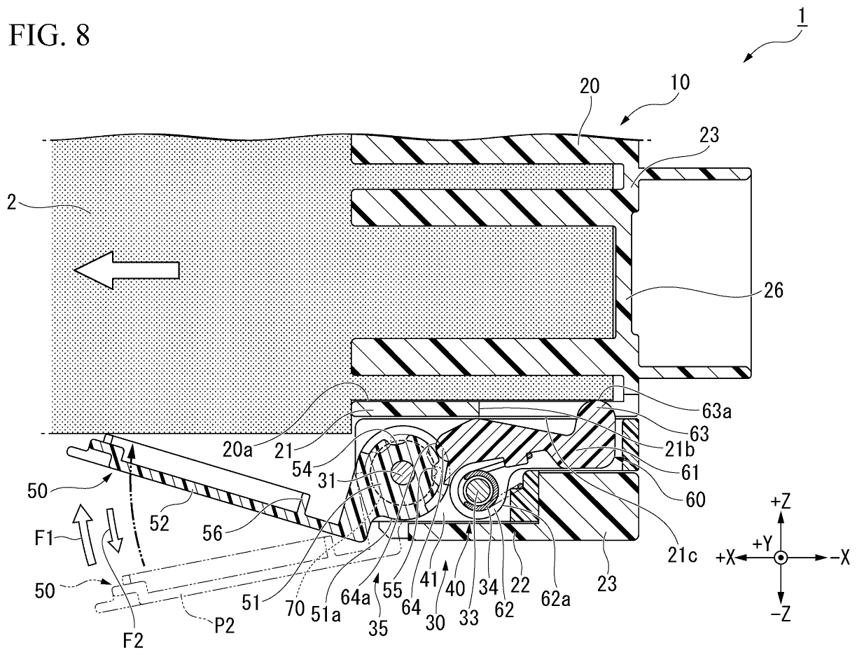

FIG. 8 is a schematic cross-sectional view illustrating a structure around a cap mechanism 30 of a charging inlet 1 in the second embodiment. The cap mechanism 30 includes a damper portion 70. When the cap 50 is moved from the closing position P1, a biasing force F1 in a direction from the opening position P2 toward the closing position P1 is applied to the cap 50 by the first biasing member 32. The damper portion 70 exerts a force F2 in a direction opposite to the biasing force F1 of the first biasing member 32 to reduce the biasing force of the first biasing member 32. In the present embodiment, the damper portion 70 is attached to the first shaft 31.

In the present embodiment, the cap mechanism 30 includes the damper portion 70 that reduces the biasing force F1 of the first biasing member 32. According to such a constitution, when the cap 50 is automatically closed by the first biasing member 32 after the power feeding connector 2 is pulled out, the damper portion 70 brakes the cap 50 to reduce the closing speed of the cap 50. As a result, it is possible to reduce a collision sound generated by collision between the cap 50 and the front housing 20. Furthermore, by adjusting the force F2 of the damper portion 70, it is possible to adjust the speed at which the cap 50 is closed and to obtain a luxurious feeling.

### Third Embodiment

Next, a third embodiment will be described. The third embodiment is different from the first embodiment in that the protrusion 63 is formed to extend to be inclined with respect to the lever body 61. The constitution other than that described below is the same as that of the first embodiment.

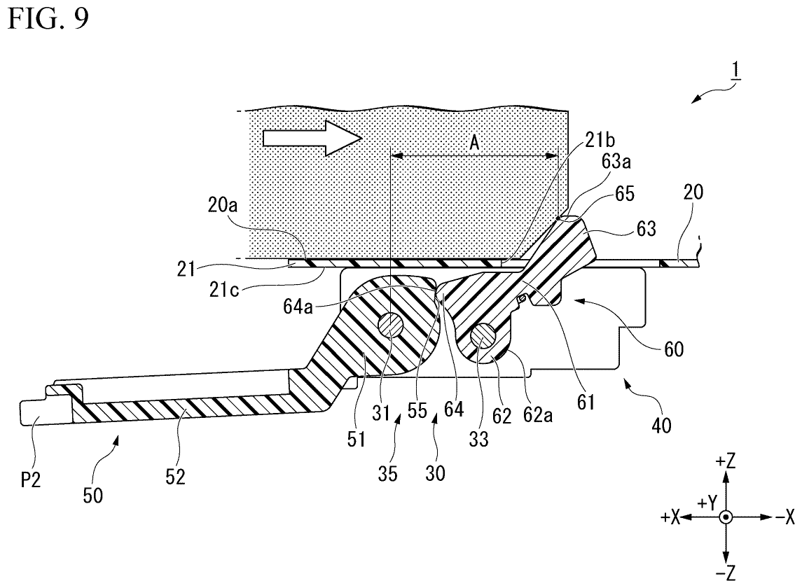

FIG. 9 is a schematic cross-sectional view illustrating a main part around a cap mechanism 30 in the third embodiment. In the present embodiment, the lever 60 has a lever body 61 (an example of the first portion) and a protrusion 63 (an example of the second portion) as in the first embodiment. The lever body 61 extends toward the back side (−X direction side) in the insertion direction of the power feeding connector 2 to connect the protrusion 63 and the engagement claw 64. Further, the protrusion 63 is provided to be bent from the lever body 61 to the inner side of the internal space 20a. The protrusion 63 extends from the lever body 61 toward the internal space 20a in the Z direction. The protrusion 63 is inclined with respect to the lever body 61 to be located on the −X direction side toward the internal space 20a in the Z direction. In a case where the power feeding connector 2 is inserted into the deepest part of the internal space, the power feeding connector 2 abuts on the protrusion 63.

According to such a constitution, a contact point 65 between the power feeding connector 2 and the protrusion 63 can be disposed on the −X direction side (rear side). Therefore, a spacing distance A between the contact point 65 and the first shaft 31 in the X direction becomes long. By increasing the spacing distance A, it is possible to further delay the timing at which the power feeding connector 2 and the protrusion 63 come into contact with each other. Thus, a timing of releasing the engagement between the engagement claw 64 and the opening engagement groove 55 is further delayed, and it is possible to further suppress the cap 50 and the power feeding connector 2 from coming into contact with each other and rubbing between the cap 50 and the power feeding connector 2.

Several embodiments and modification examples have been described above. However, the embodiments and the modification examples are not limited to the examples described above. For example, a plurality of embodiments may be implemented in combination with each other.

### REFERENCE SIGNS LIST

1 charging inlet
2 power feeding connector
10 housing
20a internal space
30 cap mechanism
32 first biasing member
34 second biasing member
35 lock mechanism
40 holder
50 cap
51 rotating portion
51a outer peripheral surface
52 cap body
55 opening engagement groove (engagement groove)
60 lever
61 lever body (first portion)
63 protrusion (second portion)
70 damper portion
P1 closing position
P2 opening position

What is claimed is:

1. A cap mechanism used for a charging inlet that is an in-vehicle component, wherein
the charging inlet includes a housing in which an internal space into which a power feeding connector is able to be fitted is formed, and
the cap mechanism comprises:
a holder attached to the housing;
a cap that is rotatably held by the holder and is movable to a closing position at which the cap covers the internal space and an opening position at which the cap opens the internal space;
a first biasing member that biases the cap toward the closing position; and
a lock mechanism that locks and holds the cap at the opening position in a case where the cap is moved to the opening position, and, in a case where the power feeding connector is inserted into the internal space, releases lock by the power feeding connector abutting, and permits the cap to move toward the closing position.

2. The cap mechanism according to claim 1, wherein
the lock mechanism includes a rotating portion that is provided integrally with the cap and has an engagement groove on an outer peripheral surface, and a lever engageable with the engagement groove,
the cap is locked and held at the opening position by the lever being engaged with the engagement groove in a case where the cap is opened at the opening position, and
the lock is released at the opening position in a manner that the power feeding connector abuts on the lever and the lever is removed from the engagement groove, in a case where the power feeding connector is inserted into the internal space.

3. The cap mechanism according to claim 2, wherein
the lock mechanism includes a second biasing member that performs biasing to hold a position of the lever in a case where the lever is engaged with the engagement groove.

4. The cap mechanism according to claim 2, wherein
the lever includes a first portion extending toward a back side in an insertion direction of the power feeding connector, and a second portion bent toward an inner side of the internal space from the first portion, the second portion on which the power feeding connector abuts in a case where the power feeding connector is inserted into the internal space.

5. The cap mechanism according to claim 1, further comprising:
a damper portion that reduces a biasing force of the first biasing member.

6. A charging inlet comprising:
the cap mechanism according to claims 1; and
the housing.
